(19) United States
(12) Patent Application Publication
(10) Pub. No.: US 2008/0028990 A1
(43) Pub. Date: Feb. 7, 2008

(54) Modified Tissue Marking Pigment And Method For Modifying Tissue Marking Pigment

(75) Inventor: Bruce Klitzman, Durham, NC (US)

Correspondence Address: FISH & RICHARDSON PC, P.O. BOX 1022, MINNEAPOLIS, MN, 55440-1022, US

(73) Assignee: FREEDOM-2, LLC, New York, NY (US)

(21) Appl. No.: 11/571,962

(22) PCT Filed: Jul. 14, 2005
(86) PCT No.: PCT/US05/24865

§ 371 Date: Jan. 11, 2007

Related U.S. Application Data
(60) Provisional application No. 60/587,864, filed on Jul. 15, 2004.

(51) Int. Cl. C09D 11/00

(52) U.S. Cl. 106/493; 106/401

(57) ABSTRACT

The invention provides a modified tissue marking pigment and a method for preparing a modified tissue marking pigment by altering protein adsorption to the surface of the pigment particle, activation of key receptors on important immune cells or altering the pigment particle morphology.

This application claims the benefit of U.S. Provisional Application No. 60/587,864, filed Jul. 15, 2004, which is incorporated herein by reference.

### BACKGROUND OF THE INVENTION

Field of The Invention

The present invention relates to immuno-modulation of a tissue marking pigment. In particular, it relates to a modified tissue marking pigment and a method for modifying the tissue marking pigment.

Tissue markings, e.g., tattoos, have been used in almost every culture throughout history. They have been found on a five thousand year old human mummy, and decorated figurines suggest their use at least fifteen thousand years ago. Tattoos have been used for many purposes including identity, beauty, artistic and spiritual expression, medicine, and magic.

In the United States, statistics are not kept on tattooing, but the practice has apparently been growing in popularity for the past few decades. The majority of tattoos are apparently obtained by people under forty years of age, including a significant proportion of teenagers. An estimated 2 million people are tattooed every year.

In the United States today, tattoo uses include not only the familiar artistic tattoo, but also permanent makeup (for example, permanent eyebrows, eyeliner, lip liner, and lip color); corrective or reconstructive pigmentation (for example, repigmentation of scar tissue or areola reconstruction on mastectomy patients); medical markings (for example, marking gastrointestinal surgery sites for future monitoring or marking locations for radiation treatment); and identification markings on animals (for example, pedigree “tags” on purebred pets).

The tissue marking procedure traditionally consists of piercing the skin with needles or similar instruments to introduce ink that typically includes inert and insoluble pigment particles having a wide distribution of sizes, which are suspended in a liquid carrier. Examples of machines typically used to apply a tattoo include an electromagnetic coil tattooing machine (such as that disclosed in U.S. Pat. No. 4,159,659 to Nightingale); a rotary permanent cosmetics application machine (such as that disclosed in U.S. Pat. No. 5,472,449 to Chou); or any manual tattooing device (such as the sterile single-use device marketed by Softap Inc., San Leandro, Calif.).

During the healing process, after tissue marking pigment has been applied, pigment particles can be affected in a variety of ways, many of which are detrimental to the appearance of the tissue marking. In particular, some small particles may readily diffuse and make the tissue marking blur. Other small particles may be taken up by the macrophages and phagocytes. Large particles may be removed from the implantation area directly through, for example, transdermal elimination, or sequestered in the extracellular matrix. Also, particles may be moved away from the implantation area to the lymphatic system.

Ultimately, what one sees as the tissue marking are the remaining particles of pigment located where they are engulfed by phagocytic skin cells (such as fibroblasts and macrophages) or are sequestered in the extracellular matrix. Transdermal elimination, diffusion and removal via the immune system tend to reduce the clarity of the tissue marking.

Skin cells are only about 5 to 30 microns in size. Thus, typically, the particles that they can easily engulf are only up to about 5 microns in their largest dimension. However, not all tissue marking pigment particles fall within this size range. Some tissue marking particles are larger, and it is difficult for the skin cells to engulf them. Particles that are, for example, from about 5 to about 50 microns in largest dimension may not be engulfed and be sequestered in the extracellular matrix. This sequestration may eventually lead to a granuloma.

Tissue markings may also be made using pigment particles even larger than 50 microns. For example, 100 micron particles may be used. Implantation of such particles into tissue, however, may provoke an extreme immune response. Typically, 5.0 micron or larger particles would not be engulfed and would remain extracellular, perhaps leading to a prolonged foreign body reaction and even a granuloma. For example, implanting 100 micron particles may lead to internal “scarring” (granuloma). In addition, even small particles of 5 micron or less may be very slowly engulfed, giving time for the migration, elimination of some small particles.

Because a tissue marking pigment of any size is a foreign object, an allergic reaction may be provoked. A consequential immune system response may cause the removal of the pigment from the implantation cite, reducing the clarity of the tissue marking.

To date, no method has been proposed to control the allocation of a tissue marking pigment within tissue by modifying the composition of the pigment. Furthermore, no method has been proposed to facilitate a desired tissue cell response to a pigment particle in order to stabilize tissue markings and prevent or reduce granuloma or other side effects.

### SUMMARY OF THE INVENTION

To overcome the above-described deficiencies of the prior art, the present invention provides an improved tissue marking pigment and a method for modifying a tissue marking pigment.

In accordance with the present invention, the markings can be applied to tissue such as skin, iris, sclera, dentin, muscles, tendons, fingernails, toenails, tissue beneath fingernails, tissue beneath toenails, tissue inside the mouth, or tissue lining internal body passages. Preferably, the tissue is skin.

The tissue marking pigment can be modified in accordance with the present invention by either increasing or decreasing protein adsorption to the surface of the tissue marking particle. This is achieved by, for example, incorporating a relatively inert, water-soluble polymer or lipopolysaccharide or an appropriate cytokine into the pigment. These materials may be incorporated into or applied onto the surface of the pigment by, for example, a coating or a self-assembled monolayer.

A water-soluble polymer is applied to a surface of a pigment particle that has a diameter of less than about 5 microns, preferably from about 1 to about 3 microns, to decrease protein adsorption. This polymer is also applied onto or incorporated into the surface of a pigment particle with a diameter greater than about 5 microns, preferably from about 20 to about 100 microns. Other polymers such as polyethylene oxide, poly anhydride or polyhydroxyethyl methacrylate may also be used.

Polyethylene glycol is a preferred water-soluble polymer. In particular, a medium polyethylene glycol with a molecular weight from about 3,000 to about 30,000 Daltons, more preferably about 18,500 Daltons, is used. (See Harris, J. M. Poly(Ethylene Glycol) Chemistry: Biotechnical and Biomedical; Sawhney A. S., Pathak C. P., Hubbell J. A., “Interfacial Photopolymerization of Poly(ethylene glycol)-based Hydrogels upon Alginate-poly(1-lysine) Microcapsules for Enhanced Biocompatibility,” Biomaterials 14:1008-16, 1993; Sawhney A. S., Pathak C. P., van Rensburg J. J., Dunn R C., Hubbell J A., “Optimization of Photopolymerized Bioerodible Hydrogel Properties for Adhesion Prevention,” J. Biomed. Mater. Res. 28:831-8, 1994).

A lipopolysaccharide, or another CD14 receptor agonist, is preferably applied into or onto the surface of the pigment particle with a diameter from about 5 to about 50 microns to increase the immune response to the particles. A variety of lipopolysaccharides can be used in the context of the present invention. For example, various bacteria-derived lipopolysaccharides can be used, such as those from E. Coli or Porplyromonas gingivalis. Cytokines, such as TNF-α, can also be used to stimulate the immune system in lieu of, or together with, lipopolysaccharides.

Besides, or in addition to, modulation of protein adsorption to the particle surface with receptor-independent molecules as described above, specific molecules, such as integrins, endotoxins or lipopolysaccharides, may be applied to the surface of the particle to interact with specific receptors (such as CD14) on the surface of cells or organelles to either suppress or heighten the aggressiveness of the immune system reaction to the particle. Alternatively, molecules such as tryptophan-aspartate-containing coat protein (“TACO”) could be covalently attached to membranes to inhibit phagosomes from fusing with lysosomes, thereby protecting the particle from the harsh degradation-inducing environment of the lysosome.

In another aspect of the present invention, the tissue marking pigment comprises at least one particle, which has on its outer surface at least one projection, protrusion, recess, indentation, opening or pore. The projections or indentations may be spaced apart by a distance (that is, have a center-to-center or peak-to-peak distance) of and/or have a length (that is, have a valley-to-peak distance) of about 0.1 micron to about 100 microns. The particle can also have a sharp edge with a curvature radius of about 0.1 to about 10 microns. The pores or openings can have a diameter or minor axis of about 0.1 micron to about 100 microns.

As used herein, a “tissue marking” is any mark created by the introduction of the pigment into tissue, typically living tissue, with the intention of permanent or long-term endurance. Markings may be invisible or any visible color, and should be detectable, for example, by the naked eye or by using a detection device. However, in certain embodiments, a marking can be a mark that is designed in advance to disappear after a predetermined time, for example after one or several months, and/or can be removed by exposure to a specific energy before the predetermined time.

As used herein, a tissue marking “pigment” is broadly defined as a substance, which, upon implantation into tissue, can provide a tissue marking having diverse colors or appearance properties. The pigment can be comprised of graphite and other carbon substances. Also, the pigment can include inorganic metal salts and brightly colored organometallic complexes, etc. In addition, the pigment may be a microencapsulate or a microparticle in accordance with U.S. Pat. No. 6,013,122 to Klitzman et al. and U.S. Pat. No. 6,814,760 B2 to Anderson et al.

As used herein, a “tattoo” is a type of tissue marking wherein the tissue is usually, but not limited to, skin.

As used herein, “diameter” refers to a diameter of a spherical body and the largest linear dimension of a non-spherical body. The tissue marking pigment particles according to the present invention can have various different shapes.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and are not intended to be limiting.

The invention has numerous advantages over known tissue marking pigments. For example, the present invention provides a tissue marking of improved uniformity and stability and helps to reduce skin inflammation.

Other features and advantages of the invention are apparent from the following detailed description and from the claims.

### BRIEF DESCRIPTION OF THE DRAWINGS

FIG. 1A is a schematic representation of a tissue marking pigment particle with a compound coated on its surface in accordance with the present invention.

FIG. 1B is a schematic representation of a tissue marking pigment particle with a compound on its surface in accordance with the present invention.

FIG. 1C is a schematic representation of another tissue marking pigment particle with a compound on its surface in accordance with the present invention.

FIG. 2 is a schematic representation of a tissue marking pigment particle with projections in accordance with the present invention.

FIG. 3 is a schematic representation of a tissue marking pigment particle with indentations in accordance with the present invention.

FIG. 4 is a schematic representation of a tissue marking pigment particle with a sharp edge in accordance with the present invention.

FIG. 5 is a schematic representation of a tissue marking pigment particle with pores in accordance with the present invention.

### DETAILED DESCRIPTION

Typically, tissue does not have the same reaction to every particle implanted therein. The type of reaction, if any, depends both on the size of the implanted particle and the immune reaction thereto. For example, when a tissue marking is applied, some small particles readily diffuse and make the tissue marking blur. Many small particles, however, are taken up by the macrophages and phagocytes or are removed from the site into the lymphatic system.

If, however, the tissue marking pigment is selectively modified to either heighten or reduce the immune system's response, the reaction of tissue to pigment particles can be controlled to form a more stable tissue marking. For example, a pigment particle can be modified to become more “visible” to the tissue's cells, thereby facilitating engulfment and preventing or reducing granuloma. Also, the pigment can be modified to become less “visible” to the tissue's cells, thereby reducing the immune response. The present invention provides such a selective modification of tissue marking pigment particles.

Tissue cells can generally engulf particles, which are smaller in size than the cells. Since, for example, skin cells are about five to thirty microns in size, they can readily engulf particles that are less than about five microns in their largest dimension. Therefore, to minimize the engulfment and to reduce the possibility that the particles are attacked and removed by the body's immune system, according to the present invention, the particles are modified so that protein adsorption to their surface is reduced. Also, as discussed below, the morphology of the particles may be altered.

Protein adsorption to the surface of a tissue marking pigment particle may be reduced by utilizing a water-soluble polymer on the particle's surface. Such polymers include polyethylene glycol (PEG), poly anhydride, polyethylene oxide, polyhydroxyethyl methacrylate, etc. Of these polymers, PEG has been widely used to reduce an immune system reaction to implants. PEG-based coatings have been used to improve the biocompatibility of implanted glucose sensors. PEG-based polymers have previously been evaluated for in vivo use as protein drug delivery devices, for postoperative adhesion prevention, and for biocompatible membranes over electrochemical sensors.

Not all PEG molecules, however, are particularly suitable for surface modifications of tissue marking particles. Short PEG molecules with a molecular weight of about 3,000 Daltons or less are not long enough to effectively reduce or prevent protein adsorption. Long PEG molecules with a molecular weight of greater than about 30,000 Daltons cannot pack densely onto the particle's surface, because they inhibit each other from attaching, which results in gaps in surface coverage. Thus, in order to more effectively achieve the goals of the present invention, the surface of the tissue marking pigment particles, particularly those that are less than about five microns, are preferably covered with PEG molecules with a molecular weight of greater than about 3,000 Daltons and 30,000 Daltons or less. In particular, PEG molecules of about 18,500 Daltons are preferred. Another approach to more effectively reduce protein adsorption to the surface of biocompatible materials is to use surface-assembled monolayers of molecules (Mrksich, M., Dike, L. E., Tien, J., Ingber, D. E., Whitesides, G. M., Exp. Cell Res. 1997, 235, 305; Mrksich, M., Whitesides, G. M. in American Chemical Society Symposium Series).

Tissue marking particles that are larger than about 5 to about 50 microns in diameter cannot be easily engulfed by tissue cells due to their size. For example, when such particles are implanted in skin, they are sequestered due to the inability of skin cells or macrophages to completely engulf them. The subsequent sequestration of the particles, however, may lead to the formation of granulomas, which is generally undesirable. Therefore, in order to form a tissue marking using particles that are particularly from about 5 to about 50 microns in diameter, the surface of such particles may be modified (either chemically or morphologically) to stimulate the macrophages or other cells to be more aggressive in reacting to the particles, thereby causing successful engulfing of particles that would otherwise remain extracellular. Specifically, coating particles with immunostimulants would stimulate the macrophages to continue the engulfing process until the pigment particles, which would normally not be engulfed, are internalized.

Additionally, even particles less than 5 micron may be slow to become engulfed. Modifying the surface of these small particles as above would stimulate the immune reaction to more quickly engulf them, leaving the particles less time to be eliminated or to migrate away from the site of initial implantation.

To increase the immune reaction to the tissue marking particles, the particles can be made to include, for example, lipopolysaccharides (LPS), cytokines, and/or leukotrienes on the surface.

Various bacteria-produced LPS, such as LPS from E. Coli or Porphyromonas gingivalis, may be used to modify the immune reaction to the particles in accordance with the present invention. Only small quantities of LPS are needed to modify the tissue marking pigment. Thus, local administration of the modified pigment advantageously does not cause adverse systemic effects.

The cytokines useful to modify protein adsorption to the surface of the tissue marking pigment particle include TNF-α. In addition to cytokines, leukotrienes such as LTB4, etc. could also be effective.

Alternatively, some tissue marking particles that are larger than 5 microns, particularly larger than about 15 microns, preferably from about 20 to about 100 microns, may be modified to minimize protein adsorption thereto. The method of modification is similar to that for particles, which are less than about 5 microns. This modification would initiate an attenuated response from the tissue cells, and is especially preferable if particles are too large for tissue cells to engulf, even when stimulated by using, for example, LPS. The tissue reaction to such particles, if they are not modified to reduce the immune response, can lead to extreme immune reactions and even intense internal scarring (granuloma).

The microencapsulates or microparticles described in U.S. Pat. Nos. 6,013,122 and 6,814,760 B2, when utilized as the tissue marking pigment, may be similarly modified, for example, by protein adsorption to their surface or coating.

There are at least three different approaches to modifying the surface of a material. First, if the surface has a polymeric structure, the surface modifying compound could be mixed into the polymer before it is polymerized or hardened. Second, the complete (full length) molecule could be attached or adsorbed to the polymer surface after polymerization or hardening by, for example, coating. Third, the modifying compound could be surface-assembled. In the surface-assembly method, low molecular weight molecules could be attached to the surface of the material and then extended by adding monomers to the exposed end or branched by adding them to the middle of the molecule. Covalently or ionically bonding the modifying compound to the surface of the particle will most likely produce the longest lasting effect.

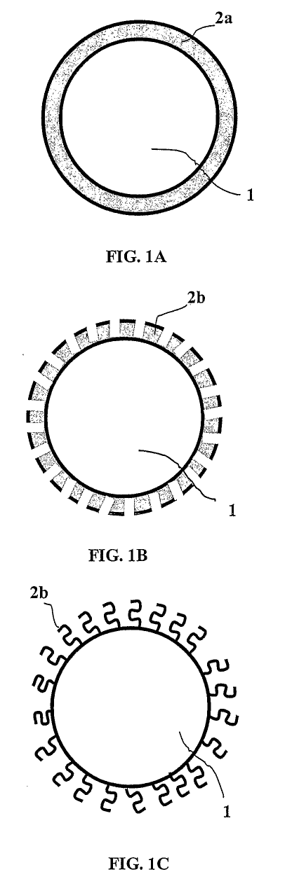

FIGS. 1A, 1B and 1C are schematic representations of tissue marking pigment particles in accordance with the above-described modifications. Specifically, FIG. 1A shows a particle 1 coated with a compound 2a, which modifies its surface properties to elicit the desired immune reaction. FIGS. 1B and 1C show different embodiments in which a compound 2b is on the surface of the particle 1.

The tissue marking pigment can also be modified in accordance with the present invention by either increasing or decreasing the stimulation of cell adhesion and engulfment by altering the morphology of the pigment. Making the pigment particle more smooth, for example, will reduce the activation of the cells. Making the pigment particle more rough, with any combination of sharp edges, protrusions and projections or indentations, openings and pores will increase the activation of cells. Making the surface more “rough” with either projections (such as “spikes”) of about 0.1 micron to about 100 microns, edges (such as a “flake”), or pores (“holes”) of 0.1 to 100 microns in diameter, or coating the particles with immunostimulants, would stimulate the macrophages to, continue the engulfing process until the pigment particles, which would normally not be engulfed, are internalized.

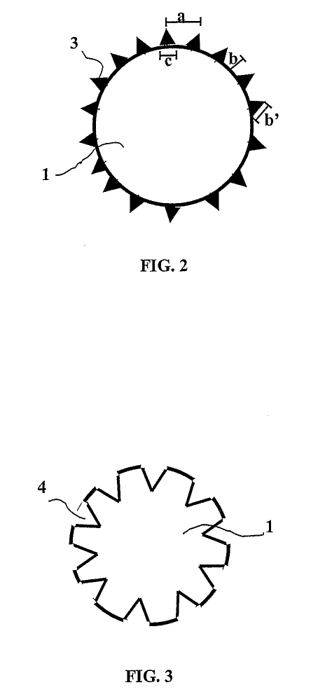

Specifically, in accordance with the present invention, the tissue marking pigment comprises at least one particle, which has on its outer surface at least one projection, protrusion, recess, indentation, sharp edge, opening or pore. FIGS. 2 and 3 schematically represent a particle 1 having projections 3 and indentations 4. The projections 3 or indentations 4 may be spaced apart by (a and c) and/or have a length (b and b′) of about 0.1 micron to about 100 microns.

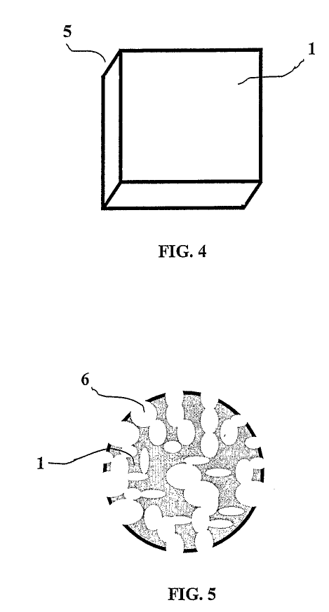

FIG. 4 show a particle 1 in accordance with the present invention, which has a sharp edge 5. A sharp edge can also have a curvature radius of about 0.1 to about 10 microns.

FIG. 5 shows a particle 1 having pores or openings 6. The pores or openings can have a diameter or minor axis of about 0.1 micron to about 100 microns.

While the invention has been described in conjunction with the detailed description thereof and the drawings, the foregoing description and drawings are intended to illustrate and not limit the scope of the invention, which is defined by the scope of the appended claims. Other aspects, advantages, and modifications are within the scope of the following claims.

What is claimed is:

1. A tissue marking pigment comprising a particle having a compound on its surface, which said compound reduces protein adsorption to the surface.

2. The pigment according to claim 1, wherein the compound is a water-soluble polymer.

3. The pigment according to claim 2, wherein the water-soluble polymer is polyethylene glycol, poly anhydride, polyethylene oxide or polyhydroxyethyl methacrylate.

4. The pigment according to claim 3, wherein the polymer is polyethylene glycol.

5. The pigment according to claim 4, wherein a molecular weight of the polyethylene glycol is from greater than about 3,000 Daltons to about 30,000 Daltons.

6. The pigment according to claim 5, wherein the molecular weight of the polyethylene glycol is about 18,500 Daltons.

7. The pigment according to claim 1, wherein a diameter of the particle is less than about 5 μm.

8. The pigment according to claim 7, wherein the diameter of the particle is from about 1 μm to about 3 μm.

9. The pigment according to claim 1, wherein a diameter of the particle is greater than about 15 μm.

10. The pigment according to claim 9, wherein the diameter of the particle from about 20 μm to about 100 μm.

11. The pigment according to claim 1, wherein the compound is covalently or ionically bonded to the surface.

12. The pigment according to claim 1, wherein molecules that interact with specific receptors on a surface of tissue cells or organelles to either suppress or heighten the aggressiveness of an immune system reaction to the particle are on the surface of the particle.

13. The pigment according to claim 12, wherein the molecules are selected from the group consisting of integrins, endotoxin, lipopolysaccharide, tryptophan-arginine containing coating protein and any combination thereof.

14. A tissue marking pigment comprising a particle having a compound on the surface, which said compound increases protein adsorption to the surface.

15. The pigment according to claim 14, wherein molecules that interact with specific receptors on a surface of tissue cells to either suppress or heighten aggressiveness of an immune system reaction to the particle are on the surface of the particle.

16. The pigment according to claim 15, wherein the molecules are selected from the group consisting of integrins, endotoxin, lipopolysaccharide and any combination thereof.

17. The pigment according to claim 14, wherein the compound is covalently or ionically bonded to the surface.

18. The pigment according to claim 14, wherein the compound is a lipopolysaccharide.

19. The pigment according to claim 18, wherein the lipopolysaccharide is obtained from E. Coli or Porphyromonas gingivalis.

20. The pigment according to claim 14, wherein the compound is a cytokine.

21. The pigment according to claim 20, wherein the cytokine is TNF-α.

22. The pigment according to claim 14, wherein the compound is a leukotriene.

23. The pigment according to claim 22, wherein the leukotriene is LTB4.

24. The pigment according to claim 14, wherein a diameter of the particle is from about 5 μm to about 50 μm.

25. A method for preparing a tissue marking pigment comprising the steps of:
providing the tissue marking pigment comprising a particle, which has a surface; and
placing a compound on the surface of the particle, which said compound reduces protein adsorption to the surface.

26. The method according to claim 25, wherein the compound is coated on the surface of the particle.

27. The method according to claim 25, wherein the compound is covalently or ionically bonded to the surface of the particle.

28. The method according to claim 25, wherein the compound is a water-soluble polymer.

29. The method according to claim 25, wherein the compound is polyethylene glycol, polyethylene oxide or polyhydroxyethyl methacrylate.

30. The method according to claim 29, wherein the polymer is polyethylene glycol.

31. The method according to claim 30, wherein a molecular weight of said polyethylene glycol is from about 3,000 Daltons to about 30,000 Daltons.

32. The method according to claim 31, wherein the molecular weight of said polyethylene glycol is about 1,500 Daltons.

33. The method according to claim 25, wherein a diameter of the particle is less than about 5 μm.

34. The method according to claim 33, wherein the diameter of the particle is from about 1 μm to about 3 μm.

35. The method according to claim 25, wherein a diameter of the particle is greater than about 15 μm.

36. The method according to claim 35, wherein the diameter of the particle is from about 20 μm to about 100 μm.

37. The method according to claim 25, wherein molecules that interact with specific receptors on a surface of tissue cells to either suppress or heighten aggressiveness of an immune system reaction to the particle are placed on the surface of the particle.

38. The method according to claim 37, wherein the molecules are selected from the group consisting of integrins, endotoxin, lipopolysaccharide and any combination thereof.

39. A method for preparing a tissue marking pigment comprising the steps of:
providing the tissue marking pigment comprising a particle, which has a surface; and
placing a compound on the surface of the particle, which said compound increases protein adsorption to the surface.

40. The method according to claim 39, wherein the compound is coated on the surface of the particle.

41. The method according to claim 39, wherein the compound is covalently or ionically bonded to the surface of the particle.

42. The method according to claim 39, wherein the compound is a lipopolysaccharide.

43. The pigment according to claim 42, wherein the lipopolysaccharide is obtained from E. Coli or Porphyromonas gingivalis.

44. The method according to claim 39, wherein the compound is a cytokine.

45. The method according to claim 44, wherein the cytokine is TNF-α.

46. The method according to claim 39, wherein the compound is a leukotriene.

47. The method according to claim 46, wherein the leukotriene is LTB4.

48. The method according to claim 39, wherein a diameter of the particle is from about 5 μm to about 50 μm.

49. The method according to claim 39, wherein molecules that interact with specific receptors on a surface of tissue cells to either suppress or heighten aggressiveness of an immune system reaction to the particle.

50. The method according to claim 49, wherein the molecules are selected from the group consisting of integrins, endotoxin, lipopolysaccharide and any combination thereof.

51. A tissue marking pigment comprising a particle having molecules on its surface, which said molecules interact with specific receptors on a surface of tissue cells to either suppress or heighten aggressiveness of an immune system reaction to the particle.

52. The pigment according to claim 51, wherein the molecules are selected from the group consisting of integrins, endotoxin, lipopolysaccharide and any combination thereof.

53. A tissue marking pigment comprising at least one particle having an outer surface, which comprises at least one projection, at least one recess, at least one indentation and/or at least one pore.

54. The pigment according to claim 53, wherein the outer surface has projections, which are spaced apart by and/or have a length of about 0.1 microns to about 100 microns.

55. The pigment according to claim 53, wherein the outer surface has said at least one pore with a diameter or minor axis of about 0.1 micron to about 100 microns.

56. The pigment according to claim 53, wherein the outer surface has indentations, which are spaced apart by and/or have a length of about 0.1 microns to about 100 microns.

57. A tissue marking pigment comprising at least one particle having an edge with a curvature radius of about 0.1 to about 10 microns.
